(19) United States
(12) Patent Application Publication
(10) Pub. No.: US 2014/0157907 A1
(43) Pub. Date: Jun. 12, 2014

(54) METER BAYONET TOOL AND METHOD OF TESTING TENSION OF METER SOCKET JAWS

(71) Applicants: David A. Johnson, Leonardtown, MD (US); Thomas L. Clarke, Mechanicsville, MD (US)

(72) Inventors: David A. Johnson, Leonardtown, MD (US); Thomas L. Clarke, Mechanicsville, MD (US)

(21) Appl. No.: 13/709,178

(22) Filed: Dec. 10, 2012

(51) Int. Cl. G01L 1/00

(52) U.S. Cl. CPC G01L 1/00
USPC 73/826

(57) ABSTRACT

A device for testing tension between the jaws of a meter socket in an electric meter base comprising an aluminum blade having dimension similar to a blade of an electric meter designed to fit in the meter socket jaw, the device further comprising a handle having a proximal end and a distal end, the blade rigidly supported within the distal end, the handle having a weight which is distributed along the handle so that sufficient torque is exerted on the blade when the blade is inserted in a meter socket to be tested that the device rotates downwardly if there is insufficient tension. A method of testing tension in a meter socket using the device is also disclosed.

### BACKGROUND OF THE INVENTION

The present invention relates to test devices, particularly to devices for testing meter socket jaw tension.

Many millions of electric meters are currently installed at home and business locations. Such meters are either the traditional type or are the relatively newer smart meter type. Regardless of type, electric meters comprise a meter base which includes four female socket jaws, alternatively known as female contacts, adapted to engage four corresponding male blades, also known as “bayonets,” projecting from a removable electric meter. The electric meter is generally removed from the meter base when electric service is disconnected at the home or business and is also removed from the meter base on a random basis to test the electric meter.

It is very important to have adequate tension within the meter socket jaw so that when the male meter blades projecting from the electric meter engage the four corresponding female meter base socket jaws, adequate electrical contact is made.

At least one portable meter socket jaw tester is currently available from Brooks Utility Products Group. The Brooks tester includes a circular gauge which measures the pressure required to insert a blade mechanically attached to the gauge into a meter base socket. The Brooks testing device used in this manner provides inaccurate and inconsistent results according to testing by the present inventor. The Brooks testing device can be used as a two piece device to check jaw tension by inserting the bayonet end into the meter socket jaw and using the hook to remove the inserted section. The device does give accurate readings when used in this fashion.

The Brooks testing device is relatively complicated, expensive, and awkward for a Meter Replacement and Repair Technician to carry in a toolbox.

It is an object of the present invention to provide a simple, cost-effective, lightweight, compact, accurate, and reliable device for testing meter socket jaw tension.

It is also an object of the invention to provide a simple, quick, durable, accurate, reliable, and effective method of testing meter socket jaws for adequate tension.

### SUMMARY OF THE INVENTION

These objects, and others as will become apparent from the following disclosure and accompanying drawings, are achieved by the present invention which comprises in one aspect a device comprising a meter blade and a handle body having weight distributed in a manner so that when the blade is inserted between the jaws of a meter socket and the handle is horizontal, sufficient torque on the meter blade is applied to cause the handle to drop if the jaw tension is below a selected level. The selected level of jaw tension is the level needed to maintain adequate electrical contact with a corresponding blade of an electric meter. According to the method aspect of the invention, if the tension between the jaws of a meter socket is insufficient to maintain the test device in a horizontal position, the socket or the entire meter base is replaced.

### BRIEF DESCRIPTION OF THE DRAWINGS

FIG. 1 is a top perspective view of a prior art device known at the Brooks testing device.

FIG. 2 is a side perspective view of a section of a device according to the invention.

FIG. 3 is a rear perspective view of a handle section of a device according to the invention.

FIG. 4 is a front plan view of a meter base which includes meter sockets having jaws which can be tested using the device of the invention.

FIG. 5 is a front perspective view of a pair of meter sockets having jaws which can be tested using the device of the invention.

FIG. 6 is a front perspective view of a device according to the invention inserted in a meter socket jaw with the proper tension for the tool to remain in a horizontal position.

FIG. 7 is a front perspective view of a device according to the invention inserted in a meter socket jaw with the improper tension for the device to remain in a horizontal position.

FIG. 8 is a schematic showing the dimensions and weight of a device according to the invention.

### DETAILED DESCRIPTION

In preferred embodiments, the handle is a plastic member which has a hexagon shaped cross section when viewed from the proximal side. A handle having a hexagon shaped cross section resembles a handle of a conventional screwdriver. Other cross-section designs are possible, including circular. The handle can be hollow, extended and sections removed to achieve the weight distribution needed to cause a selected torque on the blade member and thereby cause the handle to drop below horizontal when inadequate tension is imparted by the jaws of the meter base socket.

In some embodiments the device, the blade is constructed of aluminum and is 0.09 inches thick, 1.5 inches long, and 0.75 inches in height. The surface of the blade is preferably smooth with filed edges.

The weight of the meter bayonet tool is designed to remain horizontal when inserted in a meter socket jaw. The handle of the tool will drop to a less than horizontal position if the meter socket jaw does not have adequate tension on the meter bayonet. The weight of the meter bayonet tool in the current embodiment is designed to drop for meter socket jaw tension of less than 8 lbs. For meter socket tensions equal to or greater than 8 lbs. the handle will remain in the horizontal position.

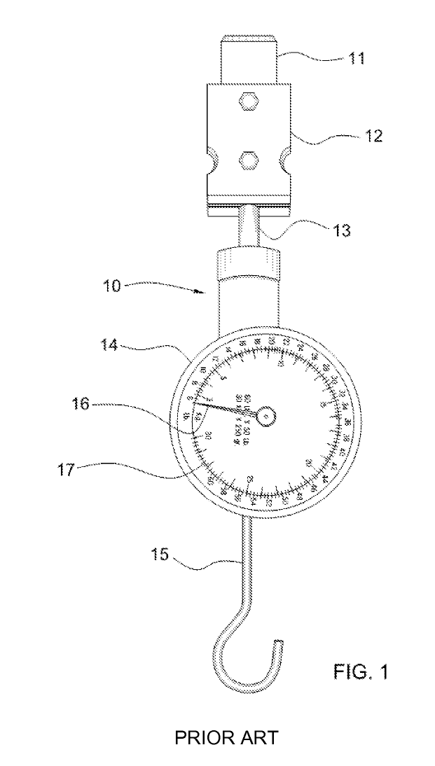

Referring now to the drawings, FIG. 1 illustrates a prior device 10 known as the Brooks testing device which includes a male blade 11, plastic support 12 for the male blade 11, plunger rod 13, meter 14 having a dial 17 with markings indicating amount of pressure needed to insert blade 11 into a pair of meter socket jaws or the pressure needed to remove the blade 11 from the jaws in order to test the tension on the jaws. The Brooks testing device 10 is designed to indicate on the meter 16 the amount of force needed to insert or remove the blade 11 from between the meter jaws and thereby test the tension the jaws exert on a blade of an electric meter which fits into the meter base.

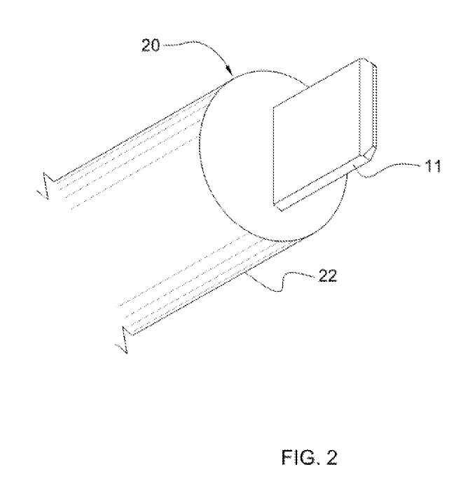

FIG. 2 illustrates an embodiment of a device 20 according to the invention wherein a male blade 11 is located at the distal end of a handle 22. The proximal portion of the handle is not illustrated in this view.

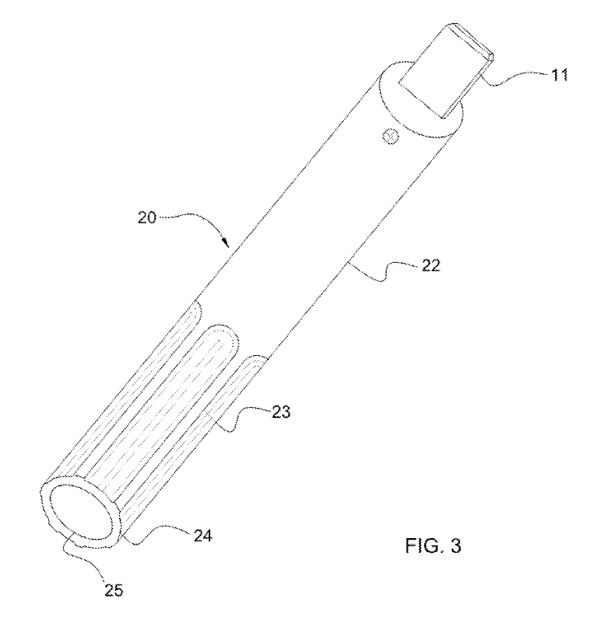

FIG. 3 illustrates an embodiment of a device 20 according to the invention wherein the blade 11 is located at the distal end of handle 22. Handle 22 includes a proximal section 23 which has a hexagonal cross-section 24 and a cylindrical section 25 removed from the center of the handle when viewed from the rear, i.e., proximal side. The proximal portion of the handle 23 is thus hollow and therefore the weight of the handle is distributed toward the distal end so as to achieve a selected, desired torque when the blade 11 is inserted within a pair of meter socket jaws.

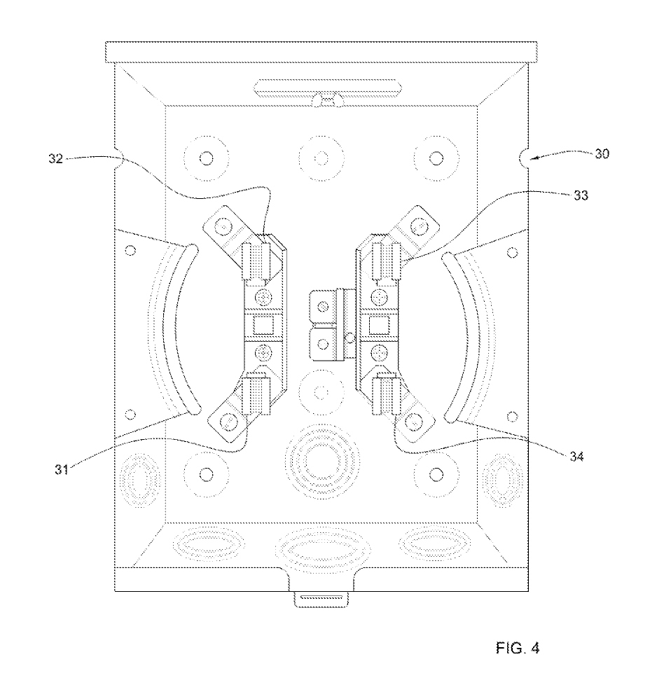

FIG. 4 illustrates a meter base 30 having meter socket jaws 31-34 oriented vertically. The meter socket jaws of a meter base are always oriented in a vertical configuration and the two jaws are always parallel to each other. When the meter socket jaws have less tension than desired, they are sometimes spread slightly apart. The male blade 11 of the testing device 20 of the invention must be inserted into the vertical opening between a set of meter socket jaws so that the male blade will be vertical and the handle will be horizontal thereby allowing a very fast and efficient test of the tension in the meter socket jaw.

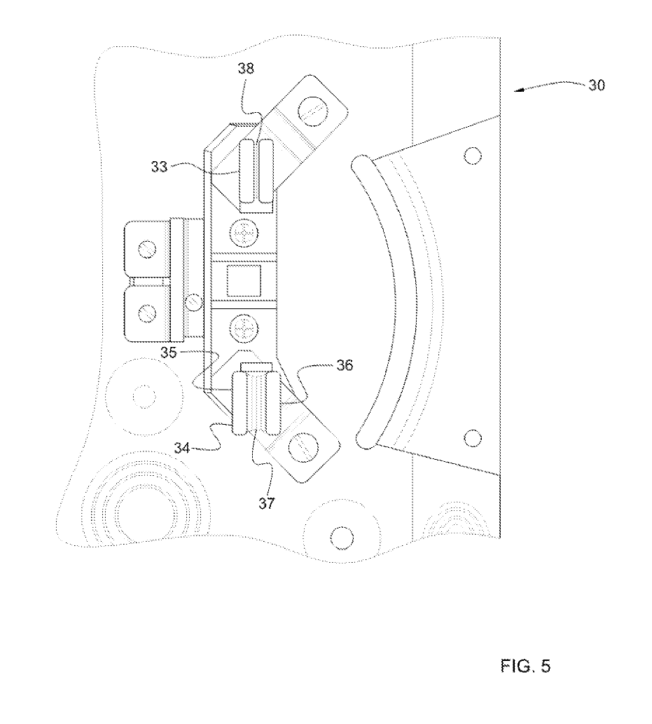

FIG. 5 illustrates only two of the meter socket jaws, 33 and 34, of a meter base, wherein the jaws 35 and 36 of socket 34 are spread apart, forming a wider opening 37 than the opening 38 within socket 33. The wider opening 37 will not support device 20 of the invention in a horizontal orientation when the male blade 11 is inserted in opening 37, but the narrower opening 38 will support the device 20 in a horizontal position when the male blade 11 is inserted.

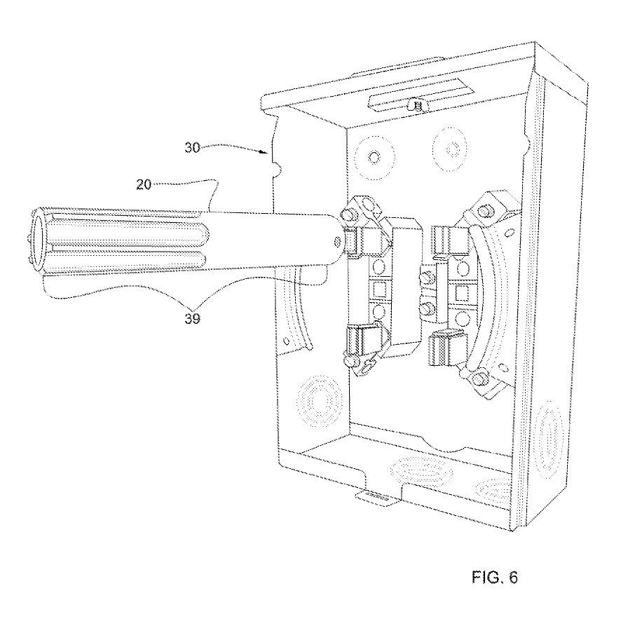

FIG. 6 illustrates the male blade (not visible) of a device 20 according to the invention inserted in a meter socket jaw 32 (not visible) in a meter base 30 in order to test the tension the meter socket jaws exert toward each other, wherein the device is maintained in a horizontal orientation 39 which indicates that there is sufficient tension.

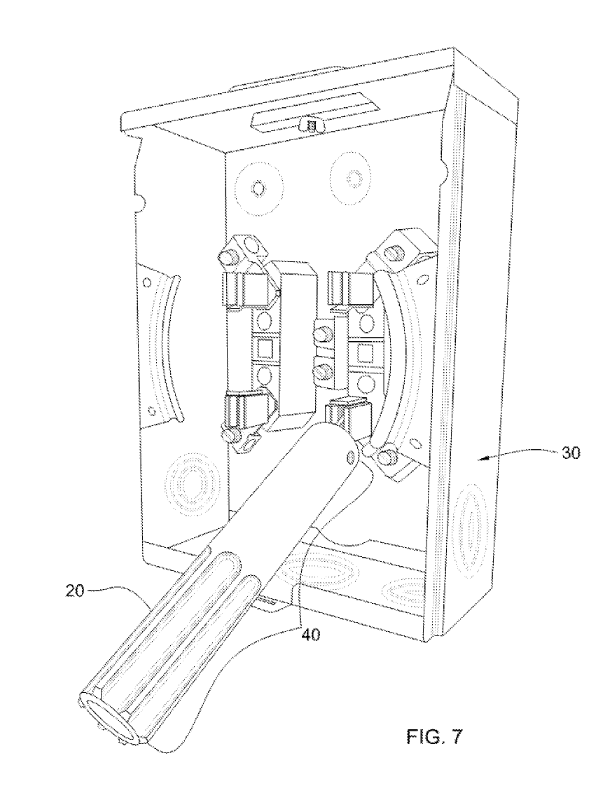

FIG. 7 illustrates the male blade 11 of a device 20 according to the invention inserted in a meter socket 34 and the device having rotated so the proximal side is below horizontal 40 compared with the blade 11 and socket 34 which indicates that there is insufficient tension.

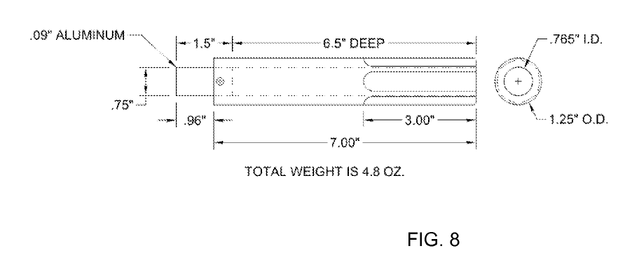

FIG. 8 illustrates the dimensions on how the device is constructed. The material of the blade is made of 0.09 inch thick aluminum 1.5 inches in length by 0.75 inches wide. The handle width is a 7 inch in length round piece of Delrin plastic. The total weight of the device is 4.8 ounces.

The device 20 is thus adapted to test the tension on sockets 32 and 34 and indicate by maintaining a horizontal position or rotating whether the meter socket jaw tested is good or whether it is bad and must be replaced.

The purpose of the device of the invention is to provide a meter installer with an easy to use tool to assist in determining if a meter socket jaw has the adequate tension and jaw surface contact area for the installation of an electric meter.

According to AEIC-EEI-NEMA Standards for WATT-HOUR METER SOCKETS-1968, 4.08 Socket Jaw Test, a current socket jaw shall be capable of readily receiving a single tin-plated copper meter bayonet (blade) 0.750 in.×0.094 in. cross section. After twenty-five insertions and withdrawals, each blade shall require a withdrawal force of not less than 5 lbs. nor more than 25 lbs. However, this requirement does not apply to sockets equipped with mechanical jaw release mechanism.

The device of the invention is to be used in conjunction with the installer's overall inspection of the meter base conditions to determine if the installation is adequate for the installation of an electric meter. In addition to jaw tension and jaw surface area, the meter installer is performing a visible inspection of the meter base's components. The installer is looking for signs of wire overheating, discolored components, signs of arcing, physical deformities of the jaws or jaw mounting blocks, and physical cracks in components. The installer is also looking for signs of line and load wire tension placing undo stress on the wire connectors and subsequent meter socket jaws.

The device in some embodiments is constructed by cutting a piece of solid 1.25 inch diameter Delrin Plastic to a length of 7 inches and cutting a piece of 0.09 inch aluminum to the proper size (1.5 inches×0.75 inches) and filing the edges. A slot in one end of the Delrin Plastic is machined for the blade to be inserted and the opposite end of the Delrin Plastic is bored to the inside dimension of 0.765 inches by 6.5 inches deep. Slots at the bored end of the handle are machined to form a screw driver type handle design. Each machined slot is preferably 3.0 inches in length×0.054 inches in depth. Each machined slot shall be tapered from a width of 0.450 inches at the top to a width of 0.325 inches at the bottom. The blade is then installed into the Delrin handle leaving 1 inch of the blade exposed. A 10\32 inch hole is drilled through the handle and the blade 0.25 inches from the end of the Delrin. The hole on both sides is countersunk so the nut and bolt will be below flush on the handle. A 10\32×1 inch bolt is installed and the nut is tightened.

The blade can be made of 0.09 inch aluminum cut to 0.075 inches wide by 1.5 inches in length.

The handle is preferably made of Delrin Plastic and has a diameter of 1.25 inches. The handle can be cut to a length of 7 inches.

The total weight of the tool is most preferably 4.8 ounces. The weight of the tool and the length of the tool work in conjunction so the tool remains horizontal when placed in a meter socket jaw with a tension equal to or greater than 8 lbs.

The preferred level of tension in a meter socket jaw is a withdrawal weight equal to or greater than 8 lbs. Any tension less than 8 lbs. would require further investigation and/or possible repairs.

The tool works by inserting the aluminum blade of the device into the jaws of a meter socket. A meter socket jaw tension of 8 lbs. has been determined from field tests to allow the Meter Bayonet tool to remain in a horizontal position once inserted into the jaws of a meter socket. A meter socket jaw tension of less than 8 lbs. will allow the Meter Bayonet Tool to drop from a horizontal position which will require further inspection or repairs before a new meter is set.

The present invention, therefore, is well adapted to carry out the objects and attain the ends and advantages mentioned, as well as others inherent therein. While the invention has been depicted and described and is defined by reference to particular preferred embodiments of the invention, such references do not imply a limitation on the invention, and no such limitation is to be inferred. The invention is capable of considerable modification, alteration and equivalents in form and function, as will occur to those ordinarily skilled in the pertinent arts. The depicted and described preferred embodiments of the invention are exemplary only and are not exhaustive of the scope of the invention. Consequently, the invention is intended to be limited only by the spirit and scope of the appended claims, giving full cognizance to equivalents in all respects.

What is claimed is:

1. A device for testing tension between the jaws of a meter socket in an electric meter base comprising an aluminum metal blade having dimension similar to a blade of an electric meter designed to fit in the meter socket, the device further comprising a handle having a proximal end and a distal end, the blade rigidly supported within the distal end, the handle having a weight which is distributed along the handle so that sufficient torque is exerted on the blade when the blade is inserted in a meter socket jaw to be tested that the device rotates downwardly if there is insufficient tension.

2. The device of claim 1 wherein the handle has a hexagonal cross section when viewed from the proximal end.

3. The device of claim 1 wherein a central portion of the handle is removed so that a portion of the handle is hollow.

4. A method of testing tension between the jaws of a meter socket in an electric meter base comprising inserting the aluminum blade of a device according to claim 1 into a meter socket jaw and determining whether the handle rotates downwardly, signaling insufficient tension.
